(19) United States
(12) Patent Application Publication
(10) Pub. No.: US 2007/0001535 A1
(43) Pub. Date: Jan. 4, 2007

(54) Small motor

(76) Inventor: Hideyuki Mori, Sagamihara-shi (JP)

Correspondence Address: PILLSBURY WINTHROP SHAW PITTMAN, LLP, P.O. BOX 10500, MCLEAN, VA, 22102, US

(21) Appl. No.: 11/519,069

(22) Filed: Sep. 12, 2006

(30) Foreign Application Priority Data
Jan. 18, 2006 (JP) 2006-9413
Apr. 21, 2005 (JP) 2005-123350

(51) Int. Cl. H02K 11/00

(52) U.S. Cl. 310/239; 310/71

(57) ABSTRACT

A small motor includes: a rotor shaft having a commutator; and a motor brush in contact with the commutator of the rotor shaft. The axis of the motor brush intersects the center line of the rotor shaft at a specified angle other than a right angle. This arrangement enables the motor brush to be brought into contact with the commutator at a wide contact area. This increases the current-carrying capacitor of the motor brush, thus allowing the DC motor to be driven by a large toque without increasing the size of the motor.

### BACKGROUND

1. Field of the Invention

The present invention relates to a small motor for use in radio control and so on.

2. Background of the Invention

Toy vehicles and airplanes that run or fly by radio remote control include a DC small motor as power source.

In a DC motor, an electric current supplied from a battery is transmitted via a motor brush to a semicircular commutator in contact with the motor brush and then introduced to an armature conductor. The direction of the current is switched every half turn of a rotor having the armature conductor to provide a running torque in the same direction.

The driving torque of the DC motor depends on the amperage of the armature, which increases with an increase in armature current. Accordingly, to obtain a high driving torque, it is necessary to pass a large current to the armature conductor (armature coil) via the motor brush and the commutator, so that it is desirable to increase the current-carrying capacity of the brush in advance.

However, conventional small motors are constructed such that the motor brush intersects the center line of the rotor shaft at right angles. Therefore, increasing the size of the motor brush to increase the current-carrying capacity at the contact between the motor brush and the commutator increases the size of the motor body, thus posing the problem of difficulty in use for smaller toy vehicles or robots.

### BRIEF SUMMARY OF THE INVENTION

The invention is made in view of the above problems. Accordingly, it is an object of the present invention to provide a small motor that provides a necessary driving torque despite the small size.

In order to achieve the above object, a small motor according to an aspect of the invention includes: a motor cover; a rotor shaft having a commutator; and a motor brush in contact with the commutator of the rotor shaft. The axis of the motor brush intersects the center line of the rotor shaft at a specified angle other than a right angle.

With this structure, since the axis of the motor brush intersects the center line of the rotor shaft at a specified angle other than a right angle, the motor brush can be in contact with the commutator at a wide contact area, thus increasing the current-carrying capacitor of the motor brush. This enables the DC motor to be driven at a high toque without increasing the size of the motor.

Preferably, the small motor further includes: an end cover at one end of the motor case; and a brush holder on the end cover, the brush holder holding the motor brush at the specified angle.

Preferably, the small motor further includes a brush support plate that supports the motor brush. The brush holder includes a brush-support-plate holding section that holds the brush support plate in an inclined state. This enables the motor brush to be smoothly put in and out of the brush holder. Since the brush support plate contributes to introducing frictional heat generated by the frictional contact between the motor brush and the commutator to the outside of the brush holder, the motor-brush cooling efficiency is increased and the wear of the motor brush is decreased.

Preferably, the brush support plate has a radiation fin exposed outside the brush holder when mounted in the brush holder. This enables the frictional heat transmitted from the motor brush to the brush support plate to be efficiently released through the radiation fins to the air outside the brush holder.

Preferably, the brush-support-plate holding section is a pair of brush-support-plate engaging recesses that support engaging pieces projecting from the rims of the brush support plate. This enables the motor brush to be securely held in contact with the commutator at a specified angle only by a simple operation to bring the engaging pieces into engagement with the brush-support-plate engaging recesses.

Preferably, the small motor further includes: a bearing retainer on the end cover, the bearing retainer retaining the bearing of the rotor shaft; and a circuit board on the bearing retainer, the circuit board having a motor-drive control circuit and a light-emitting diode displaying motor drive control. This enables the circuit board to be separated from the heat generating portion and enables the state of lighting of the light-emitting diode to be checked from one end of the motor case.

Preferably, the motor case has, at the side wall and peripheral wall, an air hole for taking outside air into the motor case and discharging warm air in the motor case to the exterior. This arrangement allows effective cooling of the field coil and the commutator in the motor case which generate heat during the driving of the small motor.

Preferably, the brush holder is made of metal. This enables the heat of the motor brush in contact with the commutator to be efficiently released through the brush holder.

Preferably, the small motor further includes a spring member on the brush support plate, the spring member elastically supporting the brush. This arrangement enables the motor brush to be stably held in the brush holder without a wobble while maintaining a constant frictional resistance.

Preferably, the small motor further includes; a mounting member having a support cylinder on the end cover, the mounting member being screwed on the end cover together with the end of a conductive wire connected to the brush; and a power-supply round faston terminal connected to the end of the power-source wire and pushed into the support cylinder. This arrangement enables the length of the conductive wire to be decreased, thus preventing the electrical interference between the conductive wire and other components.

### BRIEF DESCRIPTION OF THE DRAWINGS

FIG. 1 is a perspective view of the principal part of a small motor according to an embodiment of the present invention;

FIG. 2 is a sectional view of the small motor shown in FIG. 1;

FIG. 3 is an exploded perspective view of a motor-brush mounting structure according to the embodiment;

FIG. 4 is a plan view of the small motor in FIG. 1;

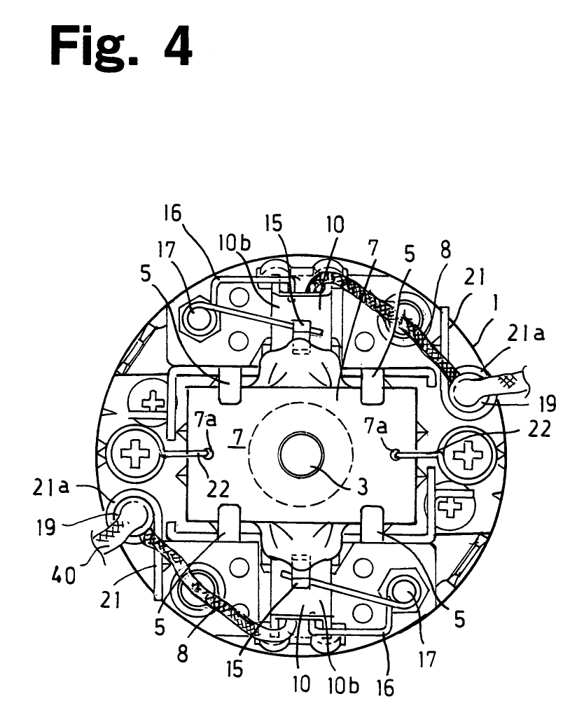

FIG. 5 is a perspective view of the principal part of a small motor according to another embodiment of the invention;

FIG. 6 is a plan view of the small motor in FIG. 5;

FIG. 7 is an exploded perspective view of another motor-brush mounting structure according to the embodiment;

FIG. 8 is a fragmentary front view of the small motor in FIG. 5;

FIG. 9 is a perspective view of the whole of the small motor in FIG. 5; and

FIG. 10 is a diagram illustrating the process of press fitting the round faston terminal into the support cylinder in FIG. 5.

### DETAILED DESCRIPTION OF THE INVENTION

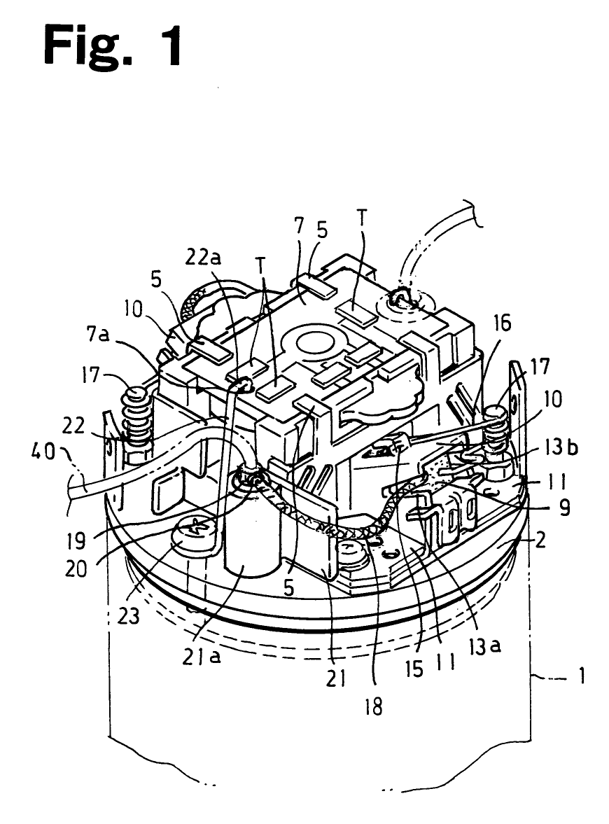

The small motor in FIG. 1 includes a closed-bottom cylindrical motor case 1 for accommodating a motor body. The motor case 1 has a ring-shaped plate end cover 2 at the open end. Although not shown because of having no relation to the principal part of the invention, the motor case 1 accommodates a stator having a field coil and a rotor having an armature coil, similarly to conventional motors.

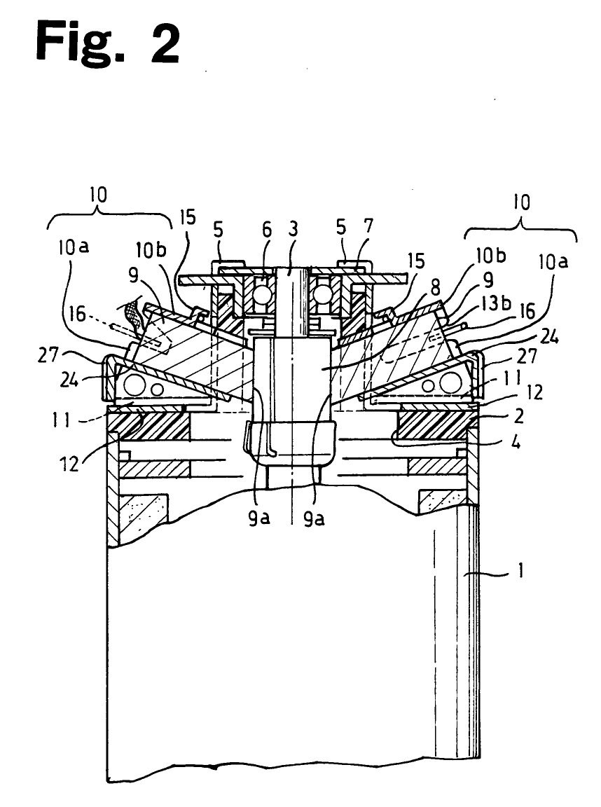

Referring to FIG. 2, the end cover 2 has a central hole 4. One end of a rotor shaft 3 passes through the central hole 4 without contact with the end cover 2. The end cover 2 has a pair of bearing retainers 5 thereon. The bearing retainers 5 are opposed to each other with the rotor shaft 3 as the center. The bearing retainers 5 retain a bearing 6 therebetween. The bearing 6 rotatably supports the upper end of the rotor shaft 3.

The bearing retainers 5 also retain a circuit board 7 therebetween. The retaining is facilitated by crimping the upper end (projection) of the bearing retainers 5. Referring back to FIG. 1, the circuit board 7 mounts circuit components T including motor-drive control IC chips.

The rotor shaft 3 is fitted with a commutator 8 made of hard copper with an insulating member (e.g., micanite) (not shown) therebetween. The commutator 8 is in contact with the ends of two motor brushes 9 made of graphite or the like. Each motor brush 9 has a rectangular cross section and is accommodated in a Ω-cross-section brush holder 10 made of a metal plate.

The brush holder 10 is integrated with mounting plates 11 disposed on the end cover 2, and is inclined toward the commutator 8 so as to be lower at the end. Each mounting plate 11 is mounted on the end cover 2 with a ring-shaped insulator 12 therebetween. The brush holder 10 accommodates a brush support plate 24 at the same inclination angle as that of the brush holder 10, on which the motor brush 9 is disposed.

Accordingly, each motor brush 9 is retained in the brush holder 10 at a specified angle so that the axis of the motor brush 9 intersects the center line of the rotor shaft 3 at an angle other than 90°. As a result, the cross-section area of an end 9a of the motor brush 9 in contact with the commutator 8 is larger than that when the motor brush 9 is cut in the direction orthogonal to the central axis of the motor brush 9. This can increase the current-carrying capacitor at the contact between the motor brushes 9 and the commutator 8 in comparison with the general DC-motor driving method in which the axis of the motor brush is in slide contact with the surface of the commutator. Thus the current-carrying capacitor can be increased without increasing the size of the motor brushes 9, so that the entire motor can be made compact, thus offering the advantage of facilitating mounting to a compact device.

The end faces of the motor brushes 9 are cut at a specified angle in advance.

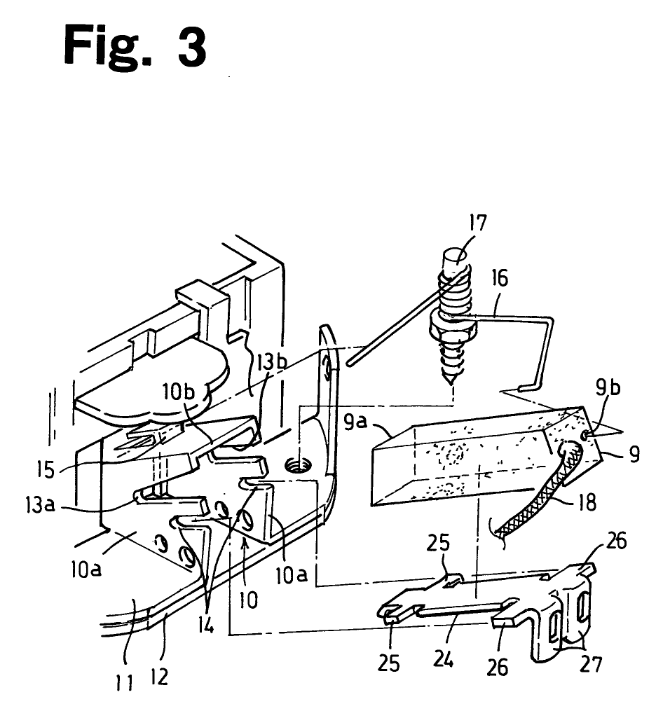

The brush holder 10 is composed of a pair of erect pieces 10a and a top plate 10b connecting the erect pieces 10a, as shown in FIG. 3. The bases of the erect pieces 10a connect to the mounting plate 11. The opposing portions of the erect pieces 10a have recesses 13a and 13b, respectively, for allowing the movement of a torsion spring 16 and the wiring of a conductive wire.

The opposing portions of the erect pieces 10a below the recesses 13a and 13b each have a brush-support-plate engaging recesses 14. The brush-support-plate engaging recesses 14 are shallower than the recesses 13a and 13b. The brush-support-plate engaging recesses 14 engage with engaging pieces 26 of the brush support plate 24.

The top plate 10b of the brush holder 10 has an L-shaped louvered spring engaging piece 15, enabling the end of the torsion spring 16 to be engaged with the spring engaging piece 15.

A column 17 shown in FIG. 3 is erected on the insulator 12 with the mounting plate 11 therebetween. The column 17 is fitted with the coil of the torsion spring 16. One end of the torsion spring 16 is inserted in an engaging hole 9b at the rear end face of the motor brush 9. The other end of the torsion spring 16 is inserted in the spring engaging piece 15 of the top plate 10b. Therefore, the torsion spring 16 has accumulated repulsive force. The repulsive force constantly pushes the motor brush 9 against the commutator 8 at a specified pressure.

The rear end of the motor brush 9 connects to a first end of a conductive wire 18 for supplying electric current to the armature coil via the commutator 8. As shown in FIG. 1, a second end of the conductive wire 18 passes through a wire through hole 20 of a round faston terminal 19. A first end of a power-source wire 40 is press fitted into the round faston terminal 19 with an inner member coated on the power-source wire 40 therebetween. The round faston terminal 19 is detachably press fitted into a support cylinder 21a. The support cylinder 21a is integrated with a mounting member 21 erected on the mounting plate 11.

The insulator 12 is fixed to the end cover 2 with screws 23. Each screw 23 is screwed into the end cover 2 in a state in which it is passed through the ring at the lower end of a retainer 22. Thus, a U-shaped retaining portion 22a at the upper end of the retainer 22 is brought into engagement with an engaging hole 7a of the circuit board 7. Thus, the circuit board 7 is stably retained to the end cover 2 with the retainers 22.

The motor brush 9 is disposed on the brush support plate 24 and inserted and supported in the brush holder 10. As shown in FIG. 3, the brush support plate 24 has guide projections 25 and the engaging pieces 26 integrally projecting from the rims of both sides thereof. The guide projections 25 are guided along the erect pieces 10a and 10b when the brush support plate 24 is mounted to the brush holder 10. The engaging pieces 26 are engaged with the brush-support-plate engaging recesses 14.

The rear end of the brush support plate 24 connects to two radiation fins 27 in L-shape. The radiation fins 27 are exposed outside the brush holder 10 with the brush support plate 24 housed in the brush holder 10.

In this small motor, the voltage of the DC source is supplied to each motor brush 9 via the round faston terminal 19 and the conductive wire 18. The voltage supplied to the motor brush 9 is transmitted to the semicircular commutator 8 and is further introduced to the rotor coil. Therefore, the direction of the armature current is switched every half turn of the rotor coil to generate a driving torque. Thus, the rotor shaft 3 continues to rotate as long as DC power is applied to the rotor coil.

In this case, the motor brush 9 is held in the brush holder 10 at an angle with respect to the center line of the rotor shaft 3, so that the motor brush 9 and the commutator 8 are in contact with each other at an area larger than the cross section area when the motor brush 9 is orthogonal to the rotor shaft 3. This arrangement can increase the current-carrying capacitor at the contact between the motor brush 9 and the commutator 8, enabling a relatively large current to be supplied to the commutator 8 and the armature winding via the motor brush 9.

The relatively large area contact between the motor brush 9 and the commutator 8 increases frictional heat generated by the contact resistance. Accordingly, in this invention, the motor brush 9 is directly supported by the brush support plate 24 and the brush support plate 24 is equipped with the radiation fins 27 exposed outside the brush holder 10.

This structure enables the generated frictional heat to be transmitted to the entire brush support plates 24 and further transmitted to the radiation fins 27 to radiate the heat to the exterior, thereby effectively cooling the motor brush 9. This reduces the wear (improves the wear resistance) of the motor brush 9.

The motor brush 9 is worn with time by the contact with the commutator 8. However, the motor brush 9 is constantly pushed to the commutator 8 by the torsion spring 16. Therefore, the contact of the motor brush 9 with the commutator 8 is continued.

The guide projections 25 stably hold the brush support plate 24 that mounts the motor brush 9 without lateral disposition in the brush holder 10. Thus, the motor brush 9 is disposed in a correct position in the brush holder 10.

After the motor brush 9 is inserted into the brush holder 10, the engaging pieces 26 of the brush support plate 24 engage with the brush-support-plate engaging recesses 14 of the brush holder 10.

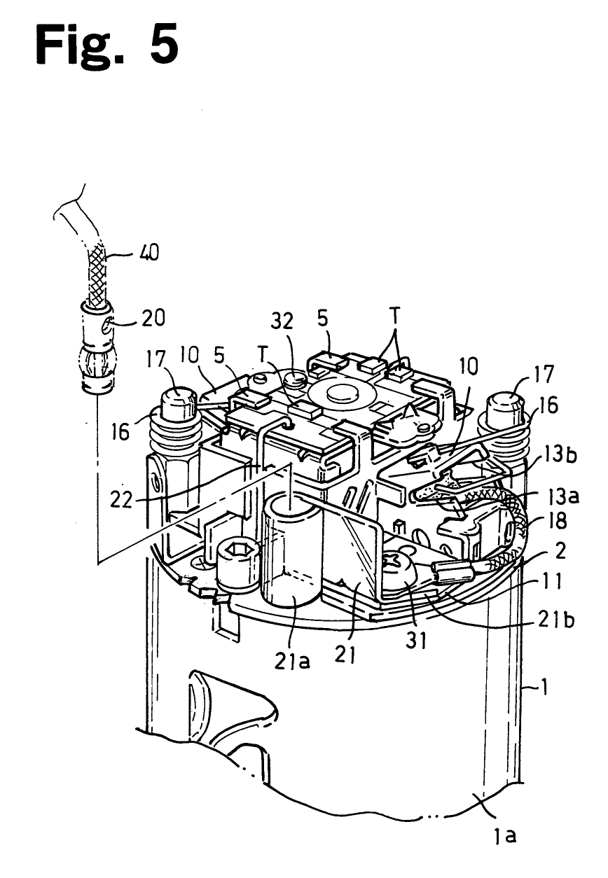

FIG. 5 is a perspective view of a small motor according to another embodiment of the invention. The same components as in FIG. 1 are given the same numerical designations and their duplicated descriptions are omitted.

In this embodiment, a mounting plate 21b extends underneath the mounting member 21 integrated with the support cylinder 21a. The mounting plate 21b is disposed on the mounting plate 11, and a screw 31 inserted from above the mounting plate 21b is screwed into the end cover 2 through the mounting plate 21b and the mounting plate 11.

The screw 31 fixes the second end (terminal plate) of the conductive wire 18 connected to the rear end of the motor brush 9 onto the mounting plate 11 with the mounting plate 21b.

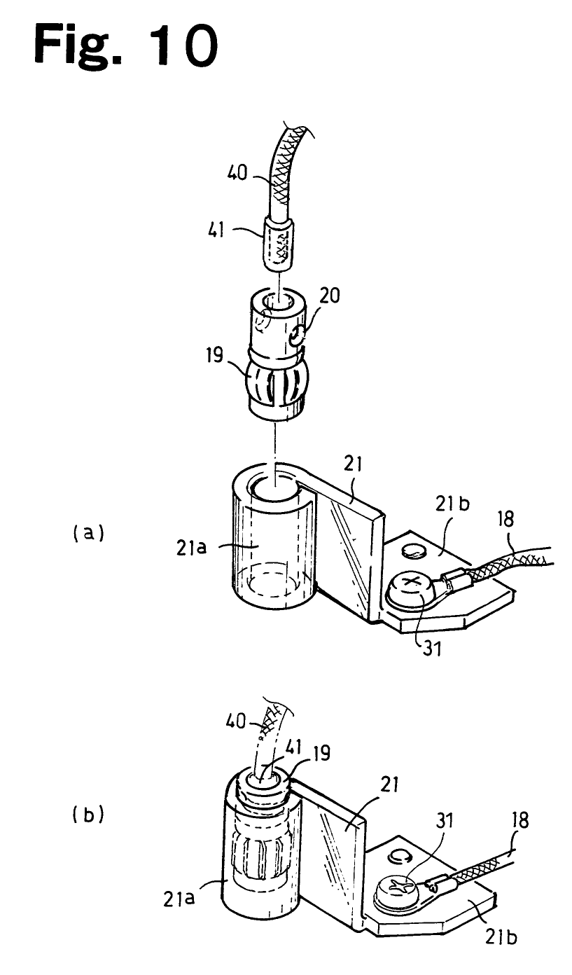

The round faston terminal 19 connected to the power-source wire 40 for introducing DC power is pressed into the support cylinder 21a. Referring to FIG. 10, an inner member 41 coated on the first end of the power-source wire 40 is pushed into the round faston terminal 19. The round faston terminal 19 has the wire through hole 20 as in the first embodiment. In the second embodiment, however, the second end of the conductive wire 18 is not connected to the wire through hole 20 but to the mounting plate 21b of the mounting member 21 with the screw 31, as shown in FIG. 5. Accordingly, the voltage of the DC source is supplied to the motor brush 9 via the round faston terminal 19, the mounting member 21, and the conductive wire 18. The voltage supplied to the motor brush 9 is transmitted to the semicircular commutator 8, and then introduced to the rotor coil.

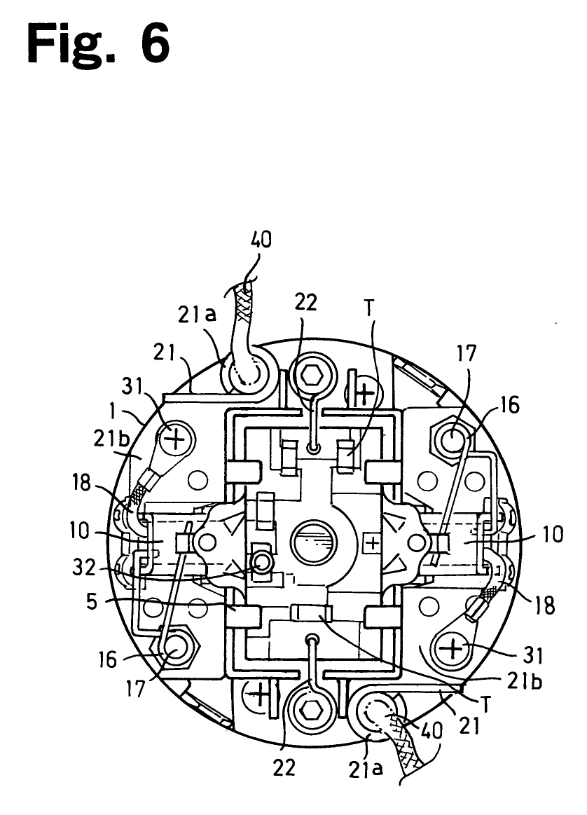

Referring to FIG. 6, this enables the entire length of the conductive wire 18 to be shorter than that shown in FIG. 1, thereby preventing electrical interference of the conductive wire 18 with other components. Also, this eliminates the troublesome work to insert the conductive wire 18 into the wire through hole 20, and facilitates and smoothes the operation of pushing the round faston terminal 19 into the support cylinder 21a.

The circuit board 7 includes a light-emitting diode (LED) 32 that emits light during controlling of motor drive in addition to the circuit components such as motor control circuits (IC chips). The light-emitting diode 32 is disposed in the position facing a window of a cap (not shown) capped on the end cover 2. The light-emitting diode 32 can display a motor-drive control state by blinking or lighting up.

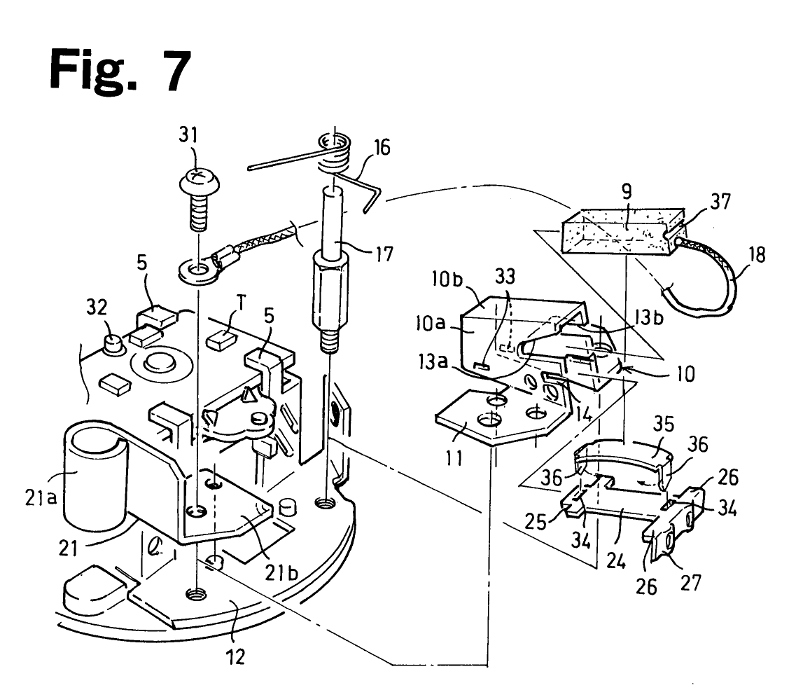

Referring to FIG. 7, the brush holder 10 is composed of the pair of erect pieces 10a and the top plate 10b connecting the top plate 10b, and the mounting plate 11 connects to the bases of the erect pieces 10a, as in the first embodiment. The opposing portions of the erect pieces 10a have the recesses 13a and 13b, respectively, for allowing the wiring of the conductive wire 18 and the movement of the torsion spring 16.

The erecting pieces 10a each have the brush-support-plate engaging recess 14 below the recess 13a or 13b. The erecting pieces 10a each have an engaging hole 33 at the part opposite to the brush-support-plate engaging recesses 14. The engaging hole 33 comes into engagement with the guide projection 25 of the brush support plate 24.

The brush support plate 24 has spring-plate engaging holes 34 at the front and rear. On the brush support plate 24, an elastic plate (spring member) 35 with a smoothed surface is placed.

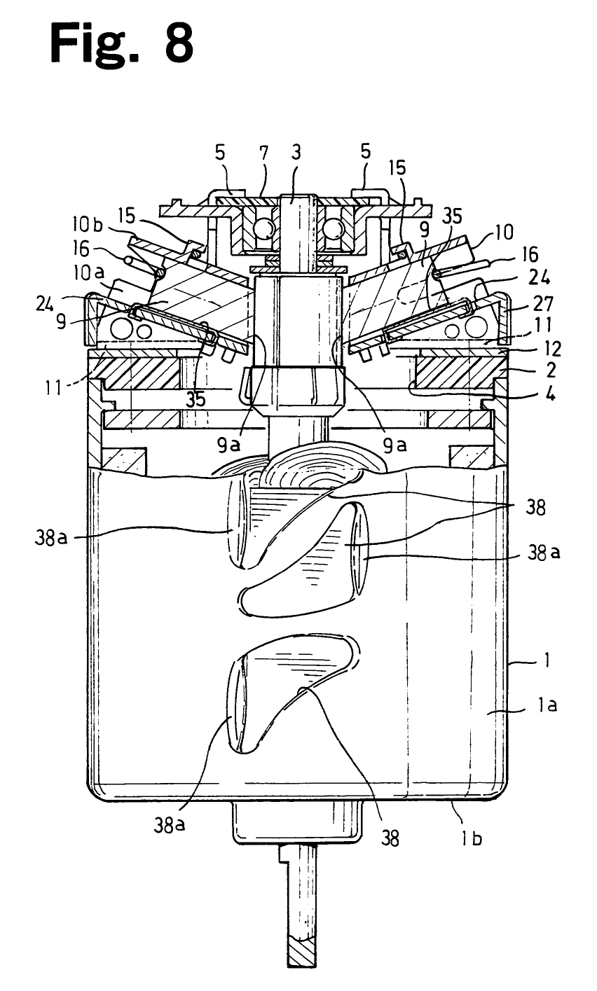

The elastic plate 35 integrally has engaging pieces 36 smaller than the elastic plate 35 on both sides. The engaging pieces 36 are folded into the spring-plate engaging holes 34. The inserted engaging pieces 36 are folded to the back of the brush support plate 24, also as shown in FIG. 8. Thus, the elastic plate 35 is mounted to the brush support plate 24. The elastic plate 35 mounted to the brush support plate 24 expands slightly upward by the elasticity to stably support the motor brush 9 inserted in the brush holder 10 without a wobble. The use of the elastic plate 35 smoothes the movement (slide) of the motor brush 9 toward the commutator 8 by the torsion spring 16.

When the brush support plate 24 is combined with the brush holder 10, the guide projections 25 of the brush support plate 24 come into engagement with the engaging holes 33 of the brush holder 10. This prevents the brush support plate 24 from coming off from the brush holder 10, thereby providing stable retention.

In this embodiment, the motor brush 9 has not the engaging hole but a horizontal groove 37 at the rear face, with which the second end of the torsion spring 16 is engaged, also as shown in FIG. 8. This facilitates engaging of the torsion spring 16 with the rear face end of the motor brush 9.

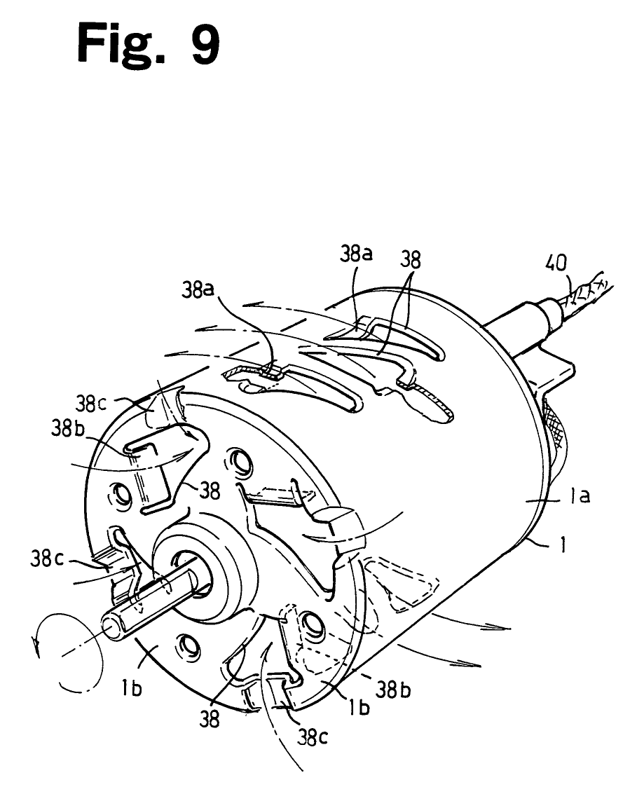

Furthermore, in this embodiment, the cylindrical part 1a and the bottom 1b of the motor case 1 have air holes (air supply and exhaust holes) 38, as shown in FIGS. 8 and 9. The air holes 38 are of substantially triangular shape. At the cylindrical part 1a, the part of the motor case 1 for the air holes 38 are diagonally pushed into the interior of the motor case 1 to form air exhaust openings 38a. When the motor is driven, warm air in the motor case 1 is guided by the air exhaust openings 38a and exhausted efficiently.

Referring to FIG. 9, at the bottom 1b, the part of the motor case 1 for the air holes 38 are louvered into the interior of the motor case 1 to form inclined pieces 38b. This allows smooth introduction of outside air into the motor case 1. The bottom 1b has specified-width outside-air intake recesses 38c extending from the outer periphery to the air holes 38. The outside-air intake recesses 38c also contribute to effective outside-air intake from the air holes 38 into the motor case 1. The inclined pieces 38b and the outside-air intake recesses 38c permit efficient cooling of the heat generating section including the contact between the commutator 8 and the motor brush 9. The warm air due to the generated heat is exhausted smoothly to the exterior through the air holes 38 of the cylindrical part 1a. This provides good cooling efficiency.

What is claimed is:

1. A small motor comprising:
a rotor shaft having a commutator; and
a motor brush in contact with the commutator of the rotor shaft, wherein
the axis of the motor brush intersects the center line of the rotor shaft at a specified angle other than a right angle.

2. The small motor according to claim 1, further comprising:
a motor case;
an end cover at one end of the motor case; and
a brush holder on the end cover, the brush holder holding the motor brush at the specified angle.

3. The small motor according to claim 2, further comprising
a brush support plate that supports the motor brush, wherein
the brush holder includes a brush-support-plate holding section that holds the brush support plate in an inclined state.

4. The small motor according to claim 3, wherein the brush support plate has a radiation fin exposed outside the brush holder when mounted in the brush holder.

5. The small motor according to claim 3, wherein the brush-support-plate holding section is a pair of brush-support-plate engaging recesses that support engaging pieces projecting from the rims of the brush support plate.

6. The small motor according to claim 2, further comprising:
a bearing retainer on the end cover, the bearing retainer retaining the bearing of the rotor shaft; and
a circuit board on the bearing retainer, the circuit board having a motor-drive control circuit and a light-emitting diode displaying motor drive control.

7. The small motor according to claim 2, wherein the motor case has, at the side wall and peripheral wall, an air hole for taking outside air into the motor case and discharging warm air in the motor case to the exterior.

8. The small motor according to claim 2, wherein the brush holder is made of metal.

9. The small motor according to claim 3, further comprising a spring member on the brush support plate, the spring member elastically supporting the brush.

10. The small motor according to claim 2, further comprising:
a mounting member having a support cylinder on the end cover, the mounting member being screwed on the end cover together with the end of a conductive wire connected to the brush; and
a power-supply round faston terminal connected to the end of the power-source wire and pushed into the support cylinder.
